(19) United States
(12) Patent Application Publication
(10) Pub. No.: US 2003/0063746 A1
(43) Pub. Date: Apr. 3, 2003

(54) Signal, storage medium, method and device for recording signal; method and device for reproducing signal

(76) Inventor: Wiebe De Haan, Eindhoven (NL)

Correspondence Address: U.S. Philips Corporation, 580 White Plains Road, Tarrytown, NY, 10591, US

(21) Appl. No.: 10/218,168

(22) Filed: Aug. 13, 2002

(30) Foreign Application Priority Data
Aug. 15, 2001 (EP) 01203109.2

(51) Int. Cl. H04N 7/167

(52) U.S. Cl. 380/201

(57) ABSTRACT

The invention relates to a signal comprising a data stream 2, 3 containing copy free data 65-67, 71, 75, 77, 83-88 and to a storage medium 15 comprising such a signal. Furthermore, the invention relates to methods and devices for recording 1 and reproducing 17 such signals. In order to avoid illegal copying of data, copy free data is encoded with a copy free signature 76, 80, 92. Thus, it is possible to discern copy free recorded material from illegal bit-true copies of decrypted material.

The invention relates to a signal containing copy free data that is allowed to be copied.

Furthermore, the invention relates to a storage medium comprising such a signal.

Furthermore, the invention relates to a method for recording a signal comprising a data stream comprising the steps of:

receiving a data stream intended to be recorded,

determining whether said received data stream is copy free,

terminating and/or prohibiting any recording in case of said received data stream not being determined as copy free,

initiating recording preparations in case of said received data stream being determined as copy free in order to generate a signal to be recorded, and

recording said signal.

Furthermore, the invention relates to a corresponding device for recording a signal comprising a data stream.

Furthermore, the invention relates to a method for reproducing data contained in a data stream of a signal as well as a corresponding device.

In the field of storing videos DVD discs and DVD players are widely spread. Commonly, DVD video discs are distributed as stamped discs. However, DVD recording devices for end users have become available. Thus, it is rendered possible to create DVD-video discs by end users. Such end user created discs are recordable discs, including writable and rewritable disc, such as DVD+RW, DVD-RW, DVD-R or DVD-RAM discs.

The creating of such recorded DVD discs may be performed either legally or illegally. In particular illegal DVD discs may be recorded when decrypted (cracked) DVD video content is recorded on such recordable DVD discs. It is therefore an aim to prevent the recording of such illegal copies.

However, the storage of legally created video material, i.e. video material created by the end user himself, e.g. by use of a digital camera, should be allowed. Such storage of legally produced video material on recordable DVD discs is ideally done in a way that is compatible with DVD-video players. However, if the DVD video format is used for this purpose without any modification, this format would be an ideal format for making bit-true copies of decrypted cracked DVD video discs.

It is therefore an object of the present invention to prevent illegal copies, however without excluding the possibility of creating legally recorded data.

This object is achieved by providing a signal comprising a data stream according to the above-mentioned type characterized in that said copy free data is encoded together with a copy free signature being reserved for copy free data only, thus forming said data stream as a copy free encoded data stream.

The object is further achieved by providing a storage medium storing such a signal.

The object is further achieved by providing a method for recording a signal comprising a data stream according to the above mentioned type characterized by said recording preparations comprising encoding said received data stream by inserting a copy free signature into said received data stream thereby generating said signal as a signal comprising a copy free encoded data stream according to the above mentioned type.

The object is further achieved by providing a corresponding device for recording a signal (14) comprising a data stream comprising:

receiving means (ANALOGUE IN, DIGITAL IN) for receiving a data stream (2, 3) intended to be recorded,

determining means for determining whether said received data stream is copy free (4, 7),

said determining means (4, 7) being designed for:

terminating and/or prohibiting (5) any recording in case of said received data stream not being determined as copy free,

initiating recording preparations (6, 8) in case of said received data stream (2, 3) being determined as copy free in order to generate a signal (14) to be recorded. and

recording means (16) for recording said signal (14) characterized by encoding means (12) for encoding said received data stream by inserting a copy free signature into said received data stream (2, 3), upon initiation of said recording preparations (6, 8), in order to generate said signal (14) as a signal comprising a copy free encoded data stream according to any one of claims 1 to 4.

Furthermore, the object is achieved by a method for reproducing data contained in a data stream of a signal characterized by the steps of: determining whether said data stream is a copy free encoded data stream comprised in a signal according to the above-mentioned type, and said reproducing being performed only in case of a copy free signature being present.

Furthermore, the object is achieved by a corresponding device for

determining means (25) for determining whether said data stream (18) is a copy free encoded data stream comprised in a signal according to any one of claims 1 to 4,

said determining means (25) being designed for performing said reproducing (23) only in case of a copy free signature being present.

The present invention of encoding copy free data with a copy free signature enables playback devices, such as DVD video playback devices to discern copy free (home) recorded content from illegal bit-true copies of decrypted data, e.g. video material of video storage media. In particular, only copy free video content is encoded with a copy free signature prior recording, whereas any other video material is not recorded at all. Thus, any legally produced recorded data stream includes such a copy free signature, whereas data not being copy free is not encoded with a copy free signature.

As a result a copy free signature compliant playback device will generally not playback data of a received data stream that does not contain such a copy free signature, since this missing copy free signature would indicate that the data stream has not been recorded legally.

However, preferably, data of a received data stream is reproduced as well if the storage medium containing the data stream is a stamped storage medium, since a stamped storage medium indicates that the storage medium has been produced by a authorized manufacturer, i.e. that the storage medium is not an illegal copy. Therefore stamped storage media are allowed to be played back even by a copy free signature compliant player.

However, it is preferred that in any other case reproducing of the data of said data stream is terminated and/or prohibited in the case of a copy free signature not being present in the encoded data stream.

Preferably said copy free signature is inserted in each addressable data unit of the data stream, such as in each video object unit of a video object on a DVD disc. Thus, it is ensured, that all parts of a data stream are indicated as a legally produced video stream. Hence, the playback of any other material, besides material from a stamped storage medium, can be rejected.

Preferably the insertion of a copy free signature is performed without affecting navigation data contained in the data stream, i.e. the copy free signature is inserted outside such navigation data. However, the copy free signature is inserted in the presentation data. Thereby, the presentation data is shifted by the amount of the inserted copy free signature.

Preferably, said copy free signature is inserted in presentation data. Preferably, said copy free signature is inserted outside of navigation data. Preferably, said copy free signature is inserted outside of a navigation pack. Preferably, said copy free signature is inserted by shifting said presentation data. Preferably, said copy free signature has a size of more than two bits in a logical sector. Preferably, said copy free signature is inserted in a predetermined video and/or audio pack of a video object unit. Preferably, said predetermined pack is the first video and/or audio pack of said video object unit. Preferably, said copy free signature is inserted as a padding packet in said video object unit. Preferably, said padding packet has a predetermined characteristic, in particular a predetermined size, number of bytes, content, and/or bit pattern. Preferably, said copy free signature is inserted by means of a user defined pack not being a video pack or an audio pack at predetermined position within a video object unit. Preferably, said predetermined position is the position of the first pack after the first video or audio pack of a video object unit. Preferably, said copy free signature is encoded by inserting a subpicture pack with predetermined content at a predetermined position. Preferably, said predetermined position is the position of the first pack after the first video or audio pack of a video object unit. Preferably, said predetermined content is an invisible subpicture information. Preferably, said predetermined content is a dummy line in the pixel data.

Further advantageous developments are defined in the dependent claims.

These and other aspects of the invention will be apparent from and elucidated with reference to the embodiments described herein after with reference to the accompanying drawings, in which:

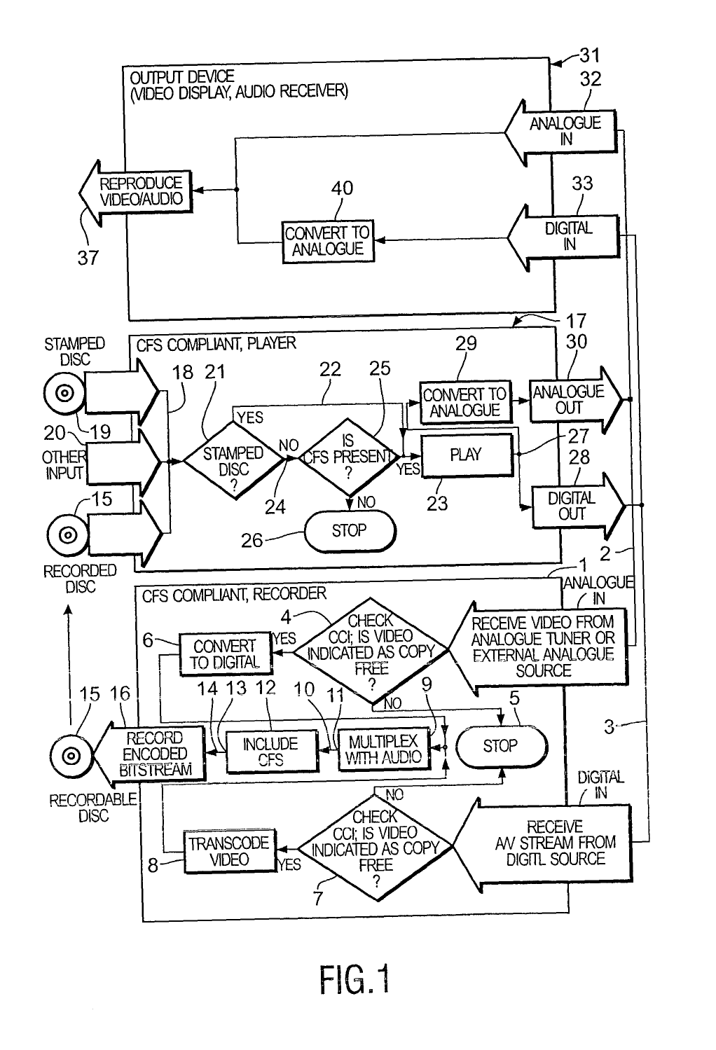

FIG. 1 shows a schematical diagram of a copy free signature compliant recorder as well as a copy free signature compliant player according to an embodiment of the present invention, and an output device;

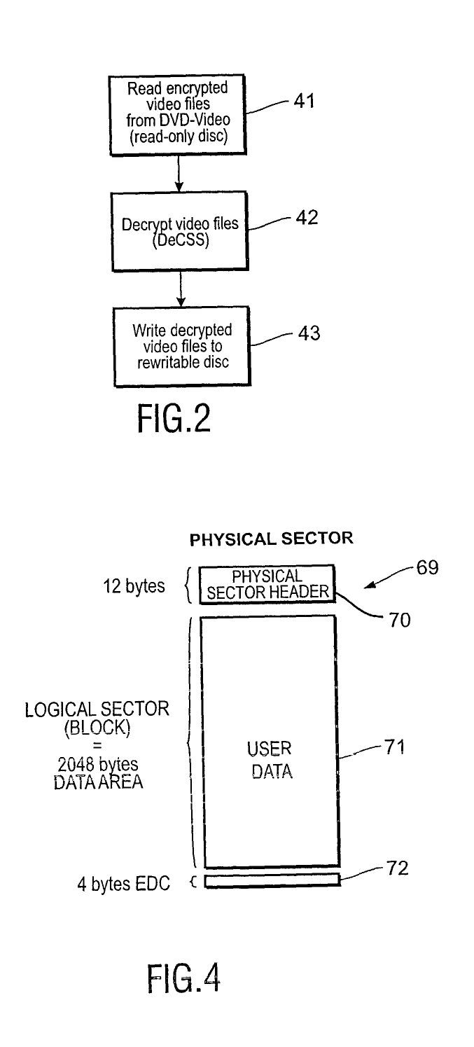

FIG. 2 shows a diagram illustrating the operation of a data recorder generating illegal video discs;

FIG. 3 shows a diagram illustrating a typical structure of a DVD disc;

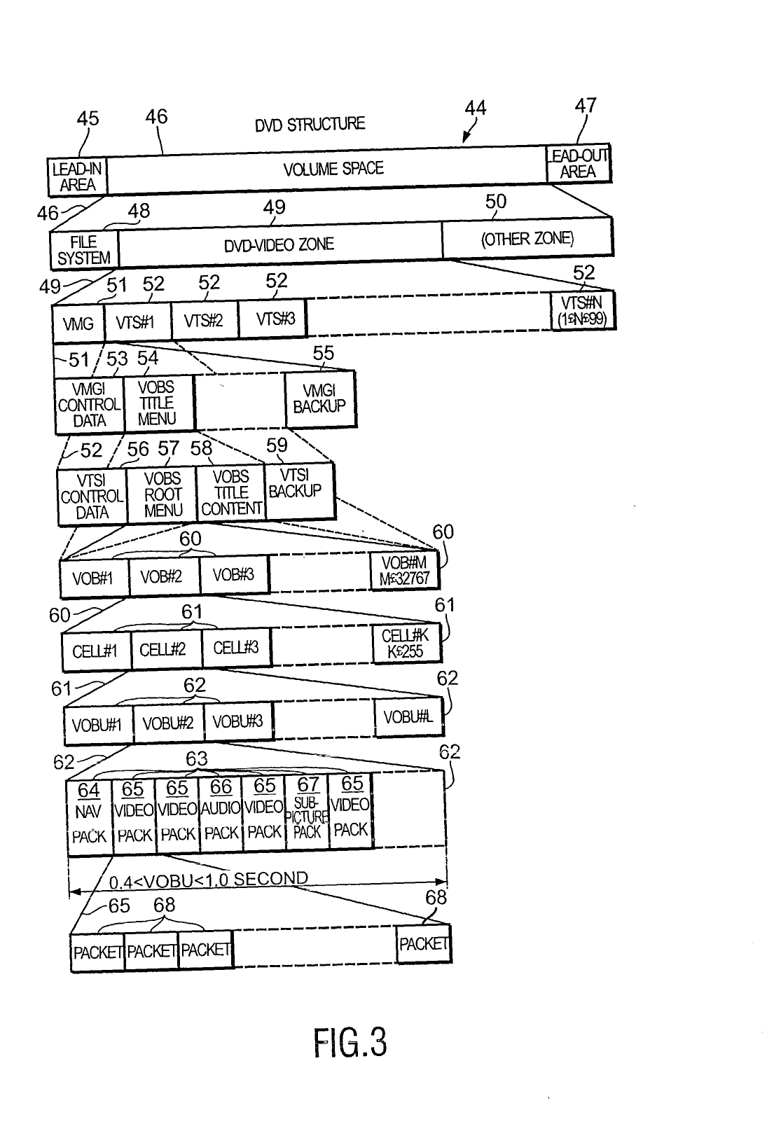

FIG. 4 shows a diagram illustrating the structure of a physical sector of a DVD disc;

FIG. 5 shows a diagram illustrating the structure of a logical sector of a DVD disc containing stream data;

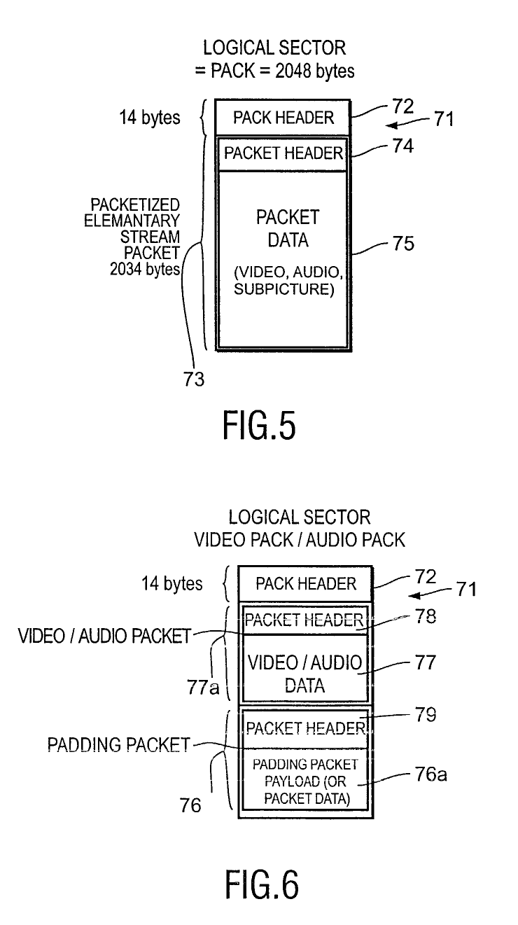

FIG. 6 shows a diagram illustrating the insertion of a copy free signature into a data stream according to an embodiment of the present invention;

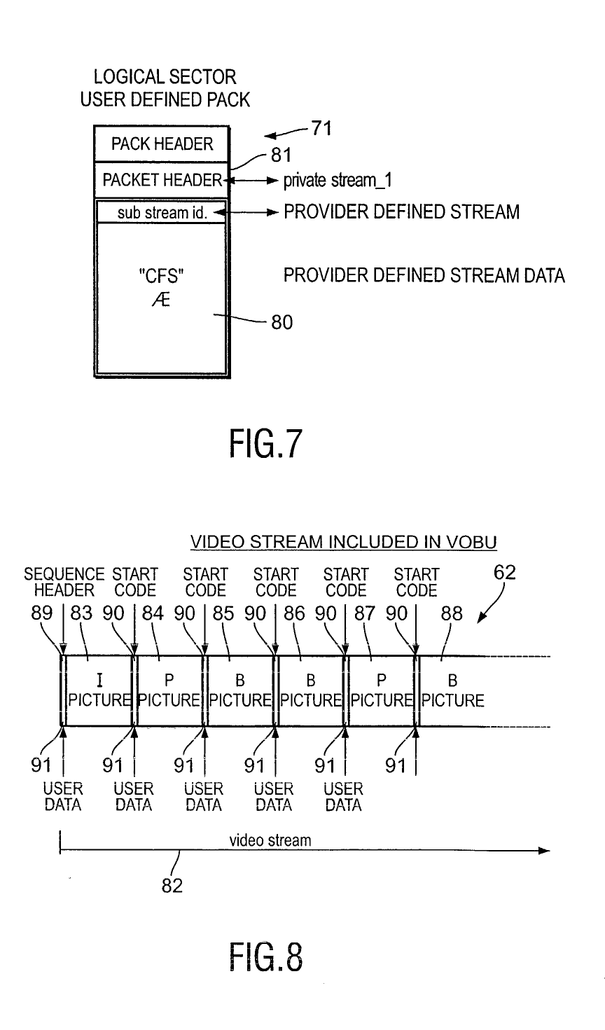

FIG. 7 shows a diagram illustrating the insertion of a copy free signature into a data stream according to a further embodiment of the present invention;

FIG. 8 shows a diagram illustrating the insertion of a copy free signature into a data stream according to a further embodiment of the present invention; and

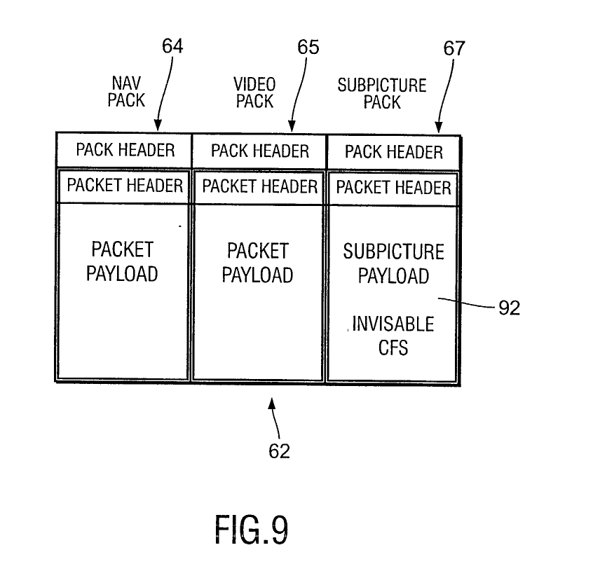

FIG. 9 shows a diagram illustrating the insertion of a copy free signature into a data stream according to a further embodiment of the present invention.

In the present invention the term “copy free” includes “copy once”, “copy twice”, . . . , i.e. the term “copy free” is to be understood as an indication for the actual copy process. However, the term “copy free” does in particular not include the indications “copy no more” and “copy never”.

The term “storage medium” (or just “medium”) includes any type of data carrier, in particular discs, e.g. optical, magnetic, magneto-optical discs, electronic cards, chip cards, magnetic tapes, etc.

Furthermore, the term “recorded disc” or “recorded medium” indicates that a recordable disc or a storage medium is recorded with data by a recorder, in contrary to the term “stamped” disc/medium that indicates that a disc has been stamped by means of a mastering process of replicating discs or storage media using a (glass) master. The term “recordable” disc or medium includes particularly any type of writable, rewritable and recordable disc or medium as well, in particular DVD-ROM, DVR-R(for General and for Authoring), DVD-RAM, DVR-RW, DVD+RW,

FIG. 1 shows a copy free signature compliant recorder 1 as well as the operation thereof. The copy free signature compliant recorder 1 comprises an analogue input 2 for receiving an analogue video signal, e.g. from an analogue tuner or external analogue source, such as an analogue camera or a analogue playback device or digital playback device with analogue output.

Furthermore, the copy free signature compliant recorder 1 may comprise a digital input 3 for receiving a digital signal, e.g. a digital data stream from a digital source, e.g. from a digital camera or a digital playback device.

The signals or data streams received via the analogue input 2 or digital input 3 are preferably audio and/or video signals. However, received digital signals may comprise alternatively or additionally digital data of any type, e.g. software code or user files.

The signal received via the analogue input 2 is directed to a copy control information checking block 4 which checks whether the received signal contains a copy control information indicating that the received signal is copy free. When it is determined in block 4 that the copy control information indicates that the received signal is not copy free, then a recording will not be performed and the recorder 1 will stop its operation as being indicated by stop block 5. Thus, the recorder 1 transits into a stop state which prohibits and/or terminates any recording process.

If, however, it is determined in the copy control information checking block 4 that the received signal is copy free, then the received signal is converted into a digital signal in the analogue-to-digital converting block 6.

A quite similar operation applies to a signal received via the digital input 3. Such a received digital signal is checked in a copy control information checking block 7 that determines whether the received signal contains a copy control information and whether this copy control information indicates the received signal as being copy free.

If the received signal is not indicated as being copy free then any recording process is terminated and/or prohibited as the recorder 1 is brought into the stop state 5.

If, however, no copy control information is found or a copy control information indicates that the received signal is a copy free signal, than the received signal is transferred to a transcode video block 8.

The transcode video block 8 performs converting of the received signal In particular the transcoding comprises the following steps:

Firstly, a decoding of the input video format to the baseband level is performed depending on the input format.

Secondly, the base band level signal is encoded into the MPEG DVD video format.

The result of the analogue-to-digital converting block is a signal of the same format as well, i.e. the analogue-to-digital converting block 6 not only converts an analogue signal into a digital signal, but encodes the digital signal into the MPEG DVD video format as well.

Next, the output of the analogue-to-digital converting block 6 or the transcode video block 8 is transmitted to a multiplex block 9 that multiplexes the received MPEG DVD video signal with audio data. The resulting multiplexed data stream 10 at the output 11 of the multiplex block 9 is transmitted to a copy free signature inserting block 12 that encodes the data stream 10 with a copy free signature CFS. Alternatively, the copy free signature may be included during video encoding, e.g. of user data, or multiplexing.

The resulting data stream (at the output 13 of the copy free signature inserting block 12) is a copy free encoded data stream 14 that is included in the signal finally to be recorded on a recordable storage medium 15. This recording is performed by a recording unit 16.

Next, the operation of a copy free signature compliant player 17 will be described. The player 17 comprises at least one input 18 that can receive data from a recorded disc 15, a stamped disc 19 and/or any other source, e.g. from the internet, via other inputs 20.

The copy free signature compliant player 17 considers prima facie only stamped storage media (stamped discs 19) as being legal.

Any other data not being stored on such stamped storage media (stamped discs 19) may be illegally produced copies. Such illegally produced copies shall be rejected by the copy free signature compliant player, i.e. any playback process of such material shall be prohibited and/or terminated.

However, not every data material comprised on a recorded disc 15 or received from other inputs 20 is per se illegal. The player 17 will therefore have to discern legal material from illegal material, e.g. copy free (home) recorded video material from illegal bit-true copies, e.g. of decrypted DVD video disc.

As according to the operation of the copy free signature compliant recorder 1 any legally produced copy free encoded data stream 14 comprises a copy free signature, the copy free signature compliant player 17 checks first in checking block 21 whether the received data is originated from a stamped storage medium (a stamped disc 19). In case the received material is originated from such a stamped storage medium 19 the received material is transferred via line 22 to a playback block 23 reproducing the data of the received data stream, i.e. reproducing video content stored on the stamped storage medium 19.

If, however, the received data does not originate from a stamped storage medium 19 the received data is transferred via line 24 to a copy free signature determining block 25. Determining block 25 determines whether the data stream transferred via line 24 is a copy free encoded data stream produced by a copy free signature compliant recorder 1, i.e. whether the received data stream comprises a copy free signature.

If the copy free signature determining block 25 determines that a copy free signature is not present in the received data stream, then any playback process is terminated and/or prohibited as the copy free signature compliant player 17 is brought into a stop state according to stop block 26.

If, however, the copy free signature determining block 25 determines that a copy free signature is present in the received data stream, i.e. that the received data stream is a copy free encoded data stream, then the signal is transmitted to playback block 23 in order to reproduce the video material. As the copy free signature is designed such that it is ignored by traditional DVD players a copy free encoded data stream is backward compatible with such traditional DVD players.

Playback block 23 regenerates the base band level video signal that is output via lines 27 to a digital output 28 of the copy free signature compliant player 17 or to a digital-to-analogue converting block 29 converting the digital signal into a analogue signal that is output via analogue output 30 of the copy free signature compliant player 17.

The signals output via analogue output 30 or digital output 28 can be transmitted to a copy free signature recorder 1 or to an output device 31, such as a video display or an audio receiver.

Output device 31 comprises an analogue input 32 and/or a digital input 33. An analogue signal received via analogue input 32 is transferred to an output 37, such as a CRT (cathode ray tube) and/or to loudspeakers in order to reproduce an audio and/or video signal.

A digital signal received via the digital input 33 is transmitted to a digital-to-analogue converter 40 converting this digital signal into an analogue signal that is output via output 37.

FIG. 2 shows the operation of a data recorder being basically a recording DVD drive that is used as a data drive in a personal computer (PC). By means of such a data drive end users can write all kinds of files onto a corresponding recordable disc. e.g. DVD-R. DVD-RW, DVD+RW and DVD-RAM discs. The DVD drive is not aware of the kind of data that it reads or writes. The data flow of an illegal DVD video copy process will now be described:

In reading block 41 the DVD disc drive reads encrypted video files from a DVD video disc (read-only disc). The read files are decrypted in decryption block 42 e.g. by means of so-called DeCSS software. The DeCSS software is a (illegal) software to decrypt video material that is content protected by the so-called content scrambling system (CSS).

Upon decryption of video files writing block 43 writes the decrypted video files to a recordable disc.

According to such a copy process shown in FIG. 2 a copy free signature is not present in the source, as the source is a stamped medium or disc and consequently there is no copy free signature added in the resulting disc. A player that checks on copy free signature, i.e. whether a copy free signature is present or not, will play the original disc, that is a stamped disc and therefore the player will not check on copy free signature. However, the player will not play the copy as it is a recorded disc (e.g. a rewriteable disc) and as the copy free signature is not present on that disc.

As a result illegally produced copies will not play on a copy free signature compliant player 17.

In the following the copy free signature will be explained in more detail. The copy free signature is inserted preferably into the MPEG (particularly MPEG-2) video format as stored on DVD video discs. The basic DVD structure will be described hereinafter.

FIG. 3 shows a diagram illustrating the physical data structure of a DVD video disc 44. A DVD video disc 44 comprises a lead-in area 45 in front of a volume space 46 followed by a lead-out area 47. The lead-in area 45 is a physical area preceding the data area of the volume space 46. It contains sync sectors and control data including e.g. disc keys and other information. The lead-out area 47 is a corresponding area at the end of the data area of the volume space 44.

The volume space 46 comprises a file system area 48 containing file system data, a DVD video zone 49 and possibly other zones 50.

A DVD video zone 49 comprises a video manager 50 and up to 99 video title sets. The video manager optionally contains a main menu for the disc, the so-called title menu or top menu. This menu usually comprises the table of contents for the disc. Such menu may be presented first, after inserting a disc into a player,. or after a request by the user, e.g. pushing a MENU button on the player or on the players' remote control.

The video manager 51 comprises control data stored in video manager information area 53, one or more video object sets (VOBS) 54 and a video manager information backup area 55 containing a copy of the video manager information area 53 for robustness reasons.

Each video title set 52 comprises a video title set information (VTSI) area 56 comprising control data, optionally a video object set (VOBS) 57 comprising a root menu, a video object set (VOBS) 58 containing title content and a video title set information backup area 59.

Each video object set (VOBS) comprises one or more (up to 32767) video objects (VOB) 60. A video object (VOB) 60 comprises one or more (up to 255) cells 61. A cell 61 contains a number of pictures or audio blocks and can be as short as a second or as long as a movie.

Furthermore, a cell 61 is divided into a number of video object units (VOBU) 62. A video object unit is the smallest addressable unit that can be played back separately. A video object unit 62 does not necessarily contain video. However, a video object unit 62 basically comprises a number of video fields and has a length of 0.4 to 1 seconds except of the last video object unit 62 of a cell that may have a length up to 1.2 seconds.

The video data in a video object unit 62 comprises zero or more groups of pictures. A group of picture (GOP) is the elementary unit of an MPEG video stream.

Usually a video object unit 62 comprises one such group of pictures. The video object unit 62 always begins with an MPEG sequence header which is followed by a group of picture header that, in turn, is followed by an I frame (cf. below). If the end of a group of picture in a video object unit 62 does not align with the end of the video object unit or if the next video object unit 62 does not contain video data, then a special MPEG sequence-end code must be present. Each video object unit 62 may not contain more than one such sequence-end code.

Each video object unit 62 comprises a number of packs 63. There are different types of packs 63, namely navigation (nav) packs 64, video packs 65, audio packs 66, subpicture packs 67 and further user defined packs.

The first pack 63 of a video object unit 62 is a navigation pack 64 followed by one of the above mentioned further packs, i.e. video packs 65, audio packs 66, subpicture packs 67 or user defined packs.

Each pack 63 is further subdivided into one or more packets 68. Each packet 68 represents a unit of video data according to the MPEG format containing contiguous bytes of data belonging to a single elementary stream, e.g. video, audio, control, etc.

According to the MPEG format three kinds of frame coding methods are provided. According to a first method intra-coded frames or I frames are generated in which an entire frame is compressed without using information from surrounding pictures. Such I frames serve as reference frames from which successive frames are formed. Due to such I frames random access into a stream of video is possible. Preferably two I frames are comprised in the frames of one second.

According to a second method predictive-coded, so-called P frames are produced containing motion vectors indicating the difference from a previous I frame or P frame.

According to a third method bi-directionally predictive-coded frames, so-called B frames are produced. Thereby it is looked for matching block in a frame in both forward and backward directions.

These frame coding methods use DCT (discrete cosine transform) quantization for all frame types.

Due to these methods P frames and B frames are much smaller than corresponding I frames, thus reducing the amount of data needed to store a sequence of frames without encoding according to one of these three methods. Often there are two B frames between each I or P frame, hence one second of 30 MPEG video frames is formed, e.g. according to the following sequence: I B B P B B P B B P B B P B B I B B P B B P B B P B B P B B.

FIG. 4 shows a diagram illustrating a physical sector 69 comprising a physical sector header 70 of 12 bytes followed by a logical sector or block 71 of 2048 bytes of user data followed by a 4 bytes error detection code (EDC) 72.

FIG. 5 illustrates the logical sector 71 containing stream data in more detail. Such a logical sector 71 represents a pack 63 as indicated in FIG. 3, e.g. a video pack 65, an audio pack 66, a subpicture pack 67.

Such a pack 63 or logical sector 71 comprises a pack header 72 of 14 bytes followed by a packetized elementary, stream (PES) packet 73 of 2034 bytes. This PES packet 73 comprises one packet header 74 indicating the stream type and stream number and packet data 75 containing e.g. video. audio or subpicture data.

FIG. 6 illustrates a copy free signature comprised in a copy free encoded data stream. In this embodiment a copy free signature is considered as being present if a specific, e.g. first, second, third, . . . n-the video and/or audio pack 65, 66 of a video object unit 62, i.e. a logical sector 71 contains a padding packet with certain characteristics, in particular a certain size or a certain length of bytes. If such a padding packet with certain predetermined characteristics is contained in a predetermined video or audio pack or a predetermined logical sector of a video object unit a copy free signature is considered as being present. Thus, a copy free signature may in particular be inserted into the data stream by means of a certain packet of a predetermined size or other characteristics, e.g. a certain content or bit pattern.

Such a padding packet 76 can be incorporated into a pack or logical sector 71 right after a video or audio packet 77a (comprising a packet header 78 and video/audio data 77) in case the video or audio PES packet size is less than 2034 bytes. The padding packet 76 comprises a padding packet header 79 indicating the padding stream and a padding packet payload (or packet data) 76a.

FIG. 7 illustrates a further embodiment of a copy free signature contained in a pack or logical sector 71. According to this embodiment a copy free signature is considered as being present if a predetermined pack, e.g. a first pack after the first video or audio pack of a video object unit is not a video or an audio pack but a user defined pack containing some special data packet 80. Such a user defined pack comprises a packet header 81 comprising a private stream identification. The special data packet 80 following that packet header 81 comprises a substream identifier, indicating a provider defined stream, followed by provider defined stream data, i.e. the copy free signature. This copy free signature (CFS) contains a predetermined bit pattern preferably of a predetermined data size or an arbitrary or random bit pattern of a predetermined size. The size is preferably selected such that the logical sector is completely filled up.

FIG. 8 shows a further embodiment of a copy free signature code. Specifically FIG. 8 shows a video stream 82 included in a video object unit 62. It contains a sequence of I, P and B frames (or pictures). It is noted that the boundaries of the I, P and B pictures are not necessarily synchronized to the boundaries of the packs following a navigation pack 64. Therefore, no boundaries of video, audio and/or subpicture packs are indicated in FIG. 8.

In front of the first frame (I frame) 83 following the navigation pack 64 is a sequence header 89, whereas the following frames 84 to 88 are starting with a start code 90.

Sequence header 89 and start codes 90 comprise user (defined) data 91 according to predefined rules. This user data according to predefined rules represents a copy free signature thus forming a copy free encoded data stream or video stream 82.

FIG. 9 shows a further embodiment of inserting a copy free signature into a data stream. According to this embodiment a copy free signature is considered as being present if a predetermined, e.g. first pack after a predetermined, e.g. first video pack 65 of a video object unit 62 starting with a navigation pack 64 is a subpicture pack 67 with a specific predetermined requirement. Such predetermined requirement is e.g. an invisible subpicture which is laid over the video, however, not being visible but being detectable by electronic means. The specific predetermined requirement particularly comprises a specific dummy line in the pixel data.

Thus, an invisible copy free signature 92 is comprised in a video object unit 62 at a predetermined position.

It is noted that a copy free signature may be considered present if any one of the above mentioned embodiments of a copy free signature as well as any combination thereof is present in the data stream.

The proposed copy free signature can only be added to content from a prerecorded DVD-video disc at the cost of loosing the bit-true nature at a multiplexed stream level. The proposed copy free signature is not simply a bit field within the presentation data with a certain value. In particular a copy free signature according to the present invention comprises more than two, in particular more than four bits per logical sector or per smallest addressable data unit, e.g. per video object unit. Moreover, the copy free signature is carried in certain predetermined properties of the bit stream that can easily be met when the audio and video encoding and multiplexing is done locally in the recorder, e.g. when recording from analogue sources, but are very unlikely to be found in stamped DVD video discs.

Due to the present invention the following advantages can be achieved. As bit-true copies will never include a copy free signature, copy free signature compliant players will reject recordable discs without this signature. The insertion of the copy free signature requires special software. Thus, the threshold for making illegal copies becomes considerably higher.

The insertion of a copy free signature destroys the bit-true nature of DVD video material. Moreover, the consistency between the audio/video files and the associated information files gets lost. Furthermore, pointers from within the information files into the audio/video bit stream as well as the pointers within the video object itself become inaccurate. This results in a DVD video player behaving in an unpredictable way. In addition, menus might not work any more, players might hang up, or discs might be ejected.

The insertion of a copy free signature requires more space for the copy free encoded data stream than the data stream without the copy free signature. Thus, encoding a data stream with a copy free signature might lead to files that are too big to be contained on a recorded disc. Thus, if a stamped disc is filled up with data up to its limit a copy with a copy free signature will not be possible. This makes illegal copies that are playable on copy free signature compliant players impossible. This is particularly advantageous as usually DVD video discs are encoded with the highest possible bit rate in order to make the files exactly fit on the disc.

It is noted that the present invention is not restricted to the preferred embodiment described above, but can be implemented particularly on any storage medium and even in non physical nature, when data is transmitted via any communication lines, e.g. the internet. Furthermore, the invention is not restricted to video data, but is applicable to any other kind of data as well, e.g. audio data, software application data, in particular user data files referring to any kind of application. Furthermore, the invention is not restricted to DVD disc, but is applicable to any other kind of storage media as well, e.g. CD and DVR disc as well as chip cards and tapes. Thus, the preferred embodiments may vary within the scope of the attached claims.

1. A signal comprising a data stream (2, 3) containing copy free data (65-67, 71, 75, 77, 83-88) that is allowed to be copied, characterized in that said copy free data (65-67, 71, 75, 77, 83-88) is encoded together with a copy free signature (76, 80, 92) being reserved for copy free data only, thus forming said data stream as a copy free encoded data stream (14).

2. A signal according to claim 1, characterized in that said copy free signature (76, 80, 92) is inserted in each addressable data unit.

3. A signal according to claim 1, characterized in that said copy free signature (76, 80, 92) is inserted in each video object unit (62).

4. A signal according to claim 1, characterized in that said copy free signature (76, 80, 92) is encoded by inserting user data to the video steam of a video object unit according to a predefined rule.

5. A storage medium storing a signal according to any one of claims 1 to 4.

6. A method for recording a signal (14) comprising a data stream comprising the steps of:
receiving a data stream (2, 3) intended to be recorded,
determining (4, 7) whether said received data stream (2, 3) is copy free
terminating and/or prohibiting (5) any recording in case of said received data stream (2, 3) not being determined as copy free,
initiating recording preparations (6, 8) in case of said received data stream (2, 3) being determined as copy free in order to generate a signal to be recorded (14), and
recording (16) said signal characterized by said recording preparations (6, 8) comprising encoding said received data stream by inserting (12) a copy free signature (76, 80, 92) into said received data stream (2, 3) thereby generating said signal as a signal comprising a copy free encoded data stream (14) according to any one of claims 1 to 4.

7. A device for recording a signal (14) comprising a data stream comprising:
receiving means (ANALOGUE IN, DIGITAL IN) for receiving a data stream (2, 3) intended to be recorded,
determining means for determining whether said received data stream is copy free (4, 7),
said determining means (4, 7) being designed for:
terminating and/or prohibiting (5) any recording in case of said received data stream not being determined as copy free,
initiating recording preparations (6, 8) in case of said received data stream (2, 3) being determined as copy free in order to generate a signal (14) to be recorded, and
recording means (16) for recording said signal (14) characterized by encoding means (12) for encoding said received data stream by inserting a copy free signature into said received data stream (2, 3), upon initiation of said recording preparations (6, 8), in order to generate said signal (14) as a signal comprising a copy free encoded data stream according to any one of claims 1 to 4.

8. A device according to claim 7, characterized in that said device (1) being designed for performing a method according to claim 6.

9. A method for reproducing (23) data contained in a data stream (18) of a signal, characterized by the steps of:
determining (25) whether said data stream (18) is a copy free encoded data stream comprised in a signal according to any one of claims 1 to 4,
said reproducing (23) being performed only in case of a copy free signature being present.

10. A method according to claim 9, terminating and/or prohibiting (26) any reproducing in case of a copy free signature not being present.

11. A method according to claim 9 or 10, characterized in that said signal is read from a storage medium (15) according to claim 5.

12. A method according to claim 9, characterized by detecting (21) whether said signal is stored on a stamped storage medium (19) or on a recorded storage medium (15), and in case of detection (22) of a stamped storage medium (19) the reproducing (23) is performed as well.

13. A device for reproducing (23) data contained in a data stream of a signal characterized by
determining means (25) for determining whether said data stream (18) is a copy free encoded data stream comprised in a signal according to any one of claims 1 to 4,
said determining means (25) being designed for performing said reproducing (23) only in case of a copy free signature being present.

14. A device according to claim 13, characterized by terminating and/or prohibiting (26) any reproducing (23) in case of a copy free signature not being present.

15. A device according to claim 13 or 14, characterized by reading means compatible for reading a storage medium according to claim 5.

16. A device according to claim 3, characterized by detecting means (21) for detecting whether said signal is stored on a stamped storage medium (19) or on a recorded storage medium (15) and enabling said reproducing (23) in case of-detection (22) of a stamped storage medium (19) as well.

17. A device according to claim 3, characterized in that said device (17) being designed for performing a method according to any one of claims 9 to 12.
